(19) United States
(12) Patent Application Publication
(10) Pub. No.: US 2002/0187024 A1
(43) Pub. Date: Dec. 12, 2002

(54) Apparatus for storing and moving a carrier

(75) Inventor: Jaim Nulman, Palo Alto, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/880,220

(22) Filed: Jun. 12, 2001

(51) Int. Cl. B65G 49/07

(52) U.S. Cl. 414/217

(57) ABSTRACT

An inventive loading and storage station has a plurality of storage shelves positioned above one or more docking stations. Each storage shelf is configured to store a substrate carrier. A factory load location is positioned below the docking station, and a robot having an end effector coupled to a support structure that comprises a vertical guide and a horizontal guide is configured so that the end effector may move horizontally and vertically among the docking station, the plurality of storage shelves and the factory load location so as to transport substrate carriers thereamong. In one aspect the plurality of storage shelves and at least one of the robot's vertical and horizontal guides are fixedly coupled to a support frame so as to create a modular unit. In a further aspect a conveyor is positioned below the docking station and is adapted to transport substrate carriers to the factory load location. In this aspect the conveyor and the robot's horizontal guide may extend along parallel lines.

### FIELD OF THE INVENTION

The present invention relates generally to substrate processing, and more particularly to an apparatus for storing and moving substrate carriers.

### BACKGROUND

Semiconductor devices are made on substrates, such as silicon wafers or glass plates, for use in computers, monitors, and the like. These devices are made by a sequence of fabrication steps, such as thin film deposition, oxidation or nitration, etching, polishing, and thermal and lithographic processing. Although multiple fabrication steps may be performed in a single processing apparatus, substrates must be transported between different processing tools for at least some of the fabrication steps.

Substrates are stored in carriers for transfer between processing tools and other locations. In order to ensure that a processing tool does not idle, a nearly continuous supply of unprocessed substrates should be available to the tool. Thus, loading and storage apparatuses are conventionally located adjacent each processing tool. Such loading and storage apparatuses include one or more docking stations where individual wafers are extracted from a carrier and transported to a processing tool, as well as including a plurality of storage shelves positioned above the docking stations, a factory load location for receiving carriers at the loading and storage apparatus, and a robot adapted to transfer carriers among the factory load location, the docking stations and the plurality of storage shelves. The robot consists of an end effector coupled to a support structure. Typically the support structure comprises a vertical guide and a horizontal guide configured so that the end effector may move horizontally and vertically among the docking station, the plurality of storage shelves and the factory load location.

The loading and storage apparatuses may be modularly designed (e.g. having components that are mounted to a frame typically extending in front of a single processing tool) or may be nonmodular in design (e.g., having components that may be mounted independently and typically having horizontal and/or vertical guides that extend in front of a plurality of processing tools). The factory load location of both the modular and nonmodular loading and storage apparatuses are typically positioned at the same elevation as the docking stations.

### SUMMARY OF THE INVENTION

An inventive loading and storage station has a plurality of storage shelves positioned above one or more docking stations. Each storage shelf is configured to store a substrate carrier. A factory load location is positioned below the docking station, and a robot having an end effector coupled to a support structure that comprises a vertical guide and a horizontal guide is configured so that the end effector may move horizontally and vertically among the docking station, the plurality of storage shelves and the factory load location so as to transport substrate carriers thereamong.

In one aspect the plurality of storage shelves and at least one of the robot's vertical and horizontal guides are fixedly coupled to a support frame so as to create a modular unit. In a further aspect a conveyor is positioned below (i.e., at a lower elevation than) the docking station and is adapted to transport substrate carriers to the factory load location. In this aspect the conveyor and the robot's horizontal guide may extend along parallel lines

### BRIEF DESCRIPTION OF THE DRAWINGS

FIG. 1 is a top plan view showing an inventive modular loading and storing apparatus;

FIG. 2 is a perspective side view of an inventive modular loading and storage apparatus having a stationary horizontal guide positioned at an elevation above the storage shelves;

FIG. 3 is a perspective side view of an inventive modular loading and storage apparatus having a stationary horizontal guide positioned at an elevation below the docking stations;

FIG. 4 is a perspective side view of an inventive modular loading and storage apparatus having a stationary vertical guide and a movable horizontal guide;

FIG. 5 is a perspective side view of an inventive nonmodular loading and storage apparatus having a stationary horizontal guide positioned at an elevation above the storage shelves;

FIG. 6 is a perspective side view of an inventive nonmodular loading and storage apparatus having a stationary horizontal guide positioned at an elevation below the docking stations; and

FIG. 7 is a perspective side view of an inventive nonmodular loading and storage apparatus having a stationary vertical guide and a movable horizontal guide.

### DETAILED DESCRIPTION OF THE PREFERRED EMBODIMENTS

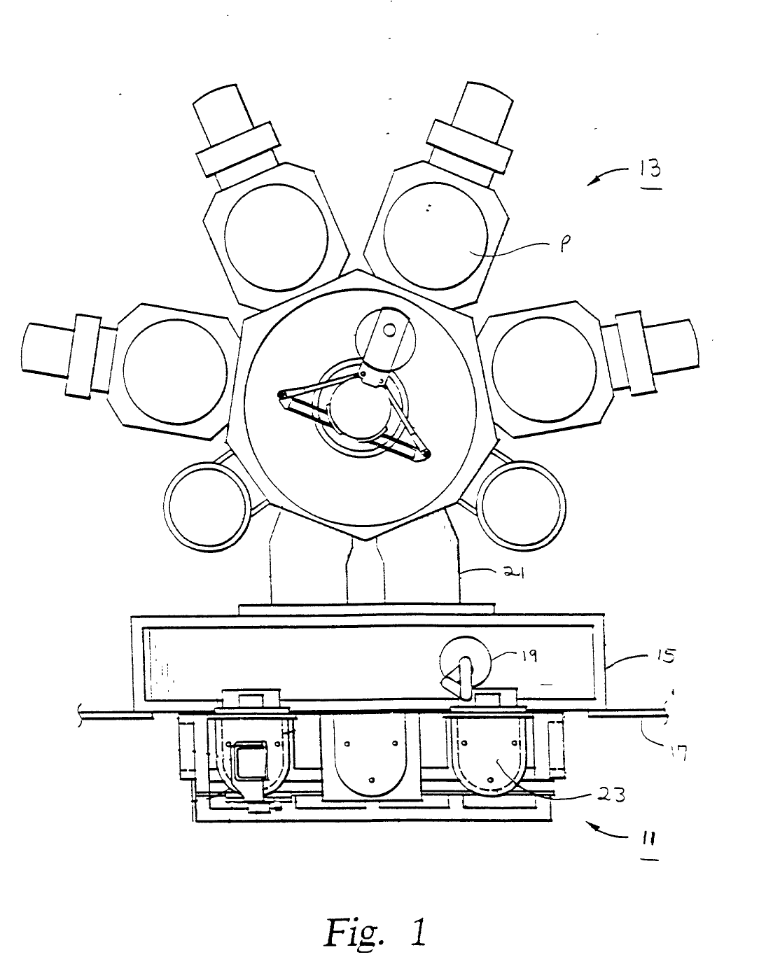

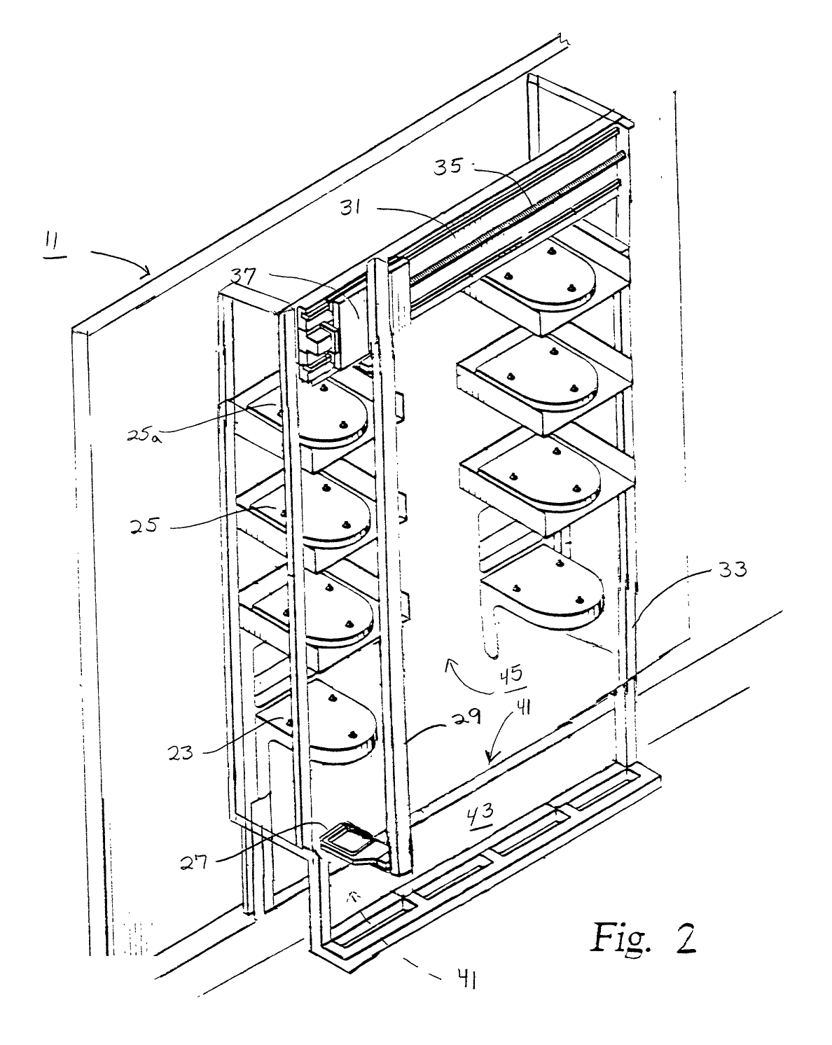

FIG. 1 is a top plan view showing an inventive modular loading and storing apparatus 11 in position for storing carriers adjacent a processing tool 13. An optional front end robot chamber 15 is shown positioned between the inventive loading and storage apparatus 11 and the processing tool 13. As shown in FIG. 1 the inventive loading and storage apparatus 11 is positioned adjacent a first side of a cleanroom wall 17 and the front end robot chamber 15 is positioned adjacent a second side of the cleanroom wall 17. The front end robot chamber 15 contains a robot 19 that may move horizontally along a track (not shown) so as to extract wafers from the loading and storage apparatus 11 and transport them to a loadlock chamber 21 of the processing tool 13. The loading and storage apparatus 11 comprises a pair of docking stations 23 where substrate carriers are placed for wafer extraction, a plurality of storage shelves 25 (best shown in FIG. 2) positioned above (e.g. at a higher elevation than) the docking stations 23. In the example of FIG. 2 the plurality of storage shelves 25 and the docking stations 23 are vertically aligned so as to occupy the same footprint (i.e., the same projected floor space)

The loading and storage apparatus 11 also comprises a robot having a support structure with an end effector 27 coupled thereto. The support structure comprises a vertical guide 29 and a horizontal guide 31 (see FIG. 2). As shown in FIG. 2, the horizontal guide 31 and the plurality of storage shelves 25 are fixedly coupled to a support frame 33. The horizontal guide 31 comprises a lead screw 35 having a mounting plate 37 movably coupled thereto. The vertical guide 29 is coupled to the mounting plate 37 so as to move therewith along the lead screw 35 of the horizontal guide 31. The vertical guide 29 may also comprise a lead screw having a mounting plate movably coupled thereto (both not shown). The end effector 27 may be coupled to the movable mounting plate (not shown) so as to move vertically therewith along the vertical guide 29.

The horizontal guide 31 is fixedly coupled to the support frame 33 at an elevation above a top storage shelf 25a of the plurality of storage shelves 25. The vertical guide 29 extends downwardly from the horizontal guide 31 to a position from which the end effector 27 can grasp a carrier 39 positioned on a factory load location 41 that is positioned at an elevation below the docking stations 23.

In the configuration of FIG. 2, a conveyor 43 extends beneath the docking stations 23 so as to be parallel to the horizontal guide 31. The conveyor 43 is adapted to transport carriers to the factory load location 41 and, as shown, the support frame 33 is configured so as not to obstruct the carrier 39 being transported by the conveyor 43. As shown in FIG. 2, the factory load location 41 is positioned below (at a lower elevation than) the docking stations 23, and an open transport channel 45 extends directly above (i.e., in the footprint of) the factory load location 41. Alternatively, as shown in phantom, the factory load location 41 may be positioned directly below (i.e., in the footprint of) the docking station 23, as long as an open path (such as the open transport channel 45) allows the end effector 27 to move the carrier 39 among the factory load location 41, the docking stations 23 and the plurality of storage shelves 25.

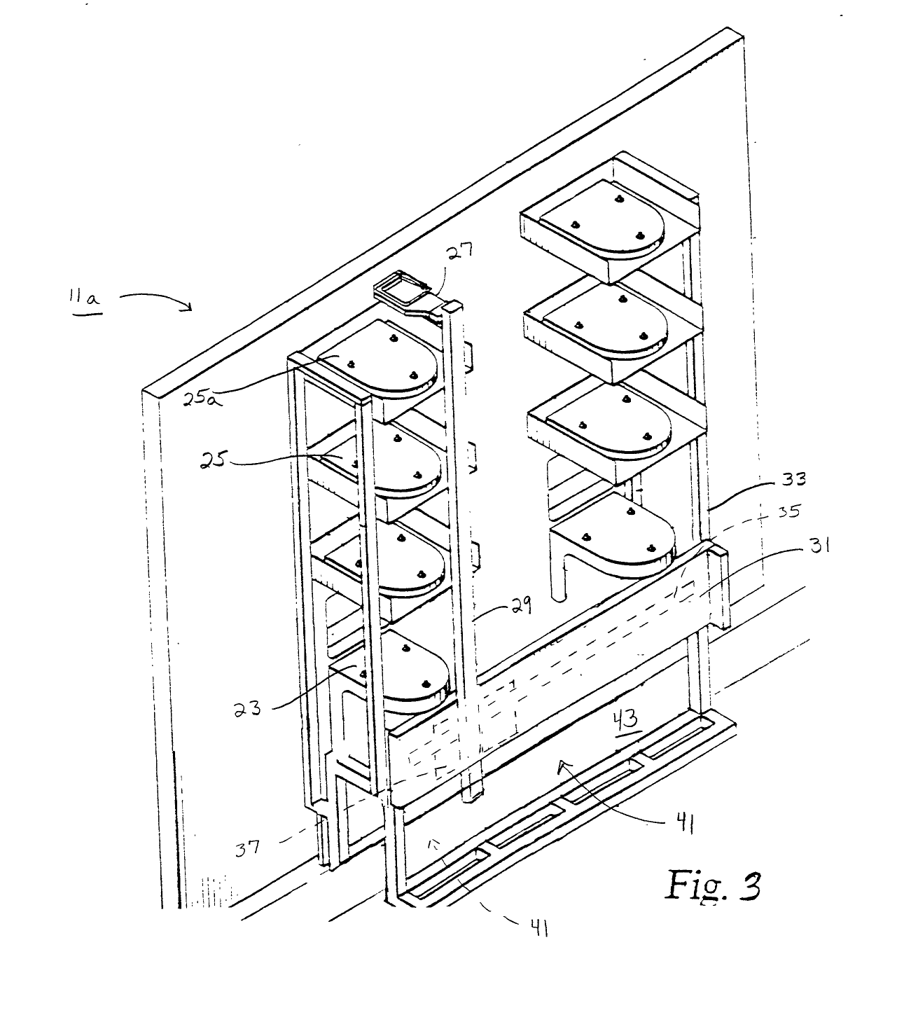

FIG. 3 shows an alternative embodiment 11a of the inventive loading and storage apparatus wherein the horizontal guide 31 is mounted below the docking stations 23 and the vertical guide 29 extends both above and below the horizontal guide 31 so as the to allow the end effector 27 to move a carrier among the factory load location 41, the docking stations 23 and the plurality of storage shelves 25. Note in this aspect the mounting plate 37 of the horizontal guide 31, and the vertical guide 29 coupled thereto, are positioned behind the lead screw 35 (closer to the docking stations 23 and closer to the plurality of storage shelves 25) such that the lead screw 35 does not obstruct movement of the end effector 27.

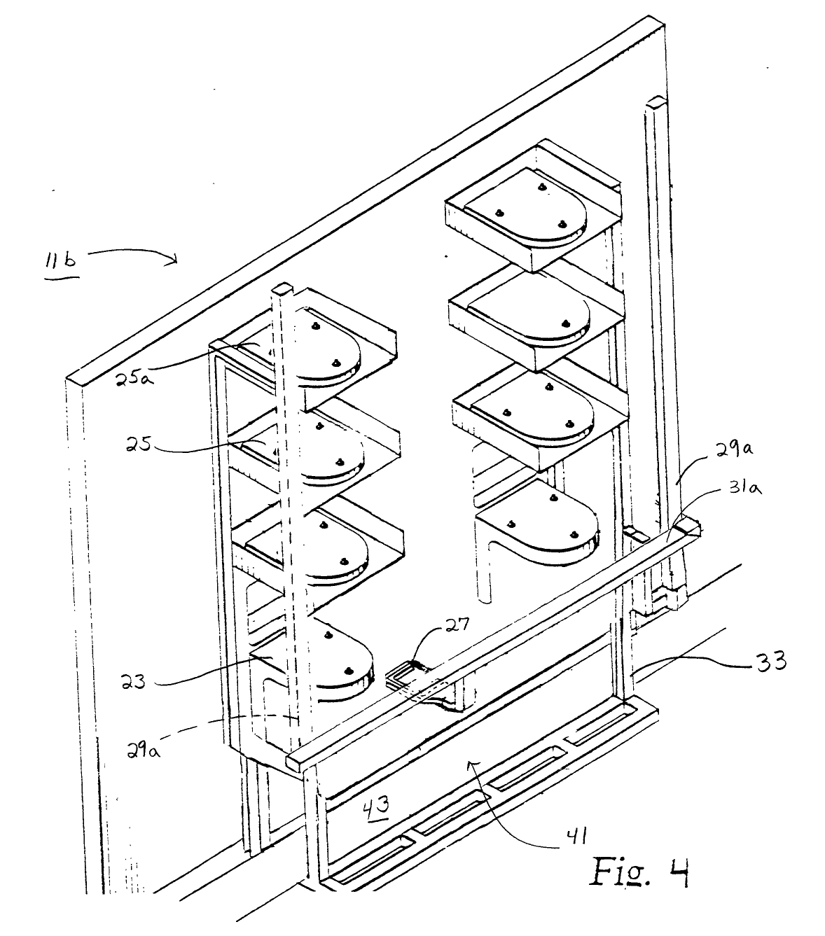

FIG. 4 shows an alternative embodiment 11b of the loading and storage apparatus wherein a stationary vertical guide 29a is fixedly coupled to the support frame 33 and a movable horizontal guide 31a is movably coupled to the vertical guide 29a. In this embodiment, like those described above, the vertical guide 29a extends vertically to a position wherein the end effector 27 can grasp a carrier located on the factory load location 41. For added strength the vertical guide 29a may comprise two parts (the second part being shown in phantom in FIG. 4) positioned along opposite sides of the support frame 33. In such an aspect the horizontal guide 31a would be coupled to both parts of the vertical guide 29a, although the horizontal guide 31a may move passively (without separate actuation) along the second part of vertical guide 29a.

In aspects such as that shown in FIG. 4, wherein the conveyor 43 extends parallel to the horizontal guide 31a, and wherein the vertical guide is stationary, the movable horizontal guide 31.a, the stationary vertical guide 29a and the end effector 27 are configured such that the end effector 27 is able to grip a carrier 39 positioned on the factory load location 41, yet the vertical guide 29a and horizontal guide 31a do not obstruct the travel of a carrier 39 traveling along the conveyor 43 (e.g. the vertical guide 29a may terminate at a vertical elevation slightly above the top of a carrier 39 positioned on the conveyor 43, and the end effector 27 may be designed so as to extend slightly below the vertical guide 29a when the end effector 27 is at the lowest point along the vertical guide 29a).

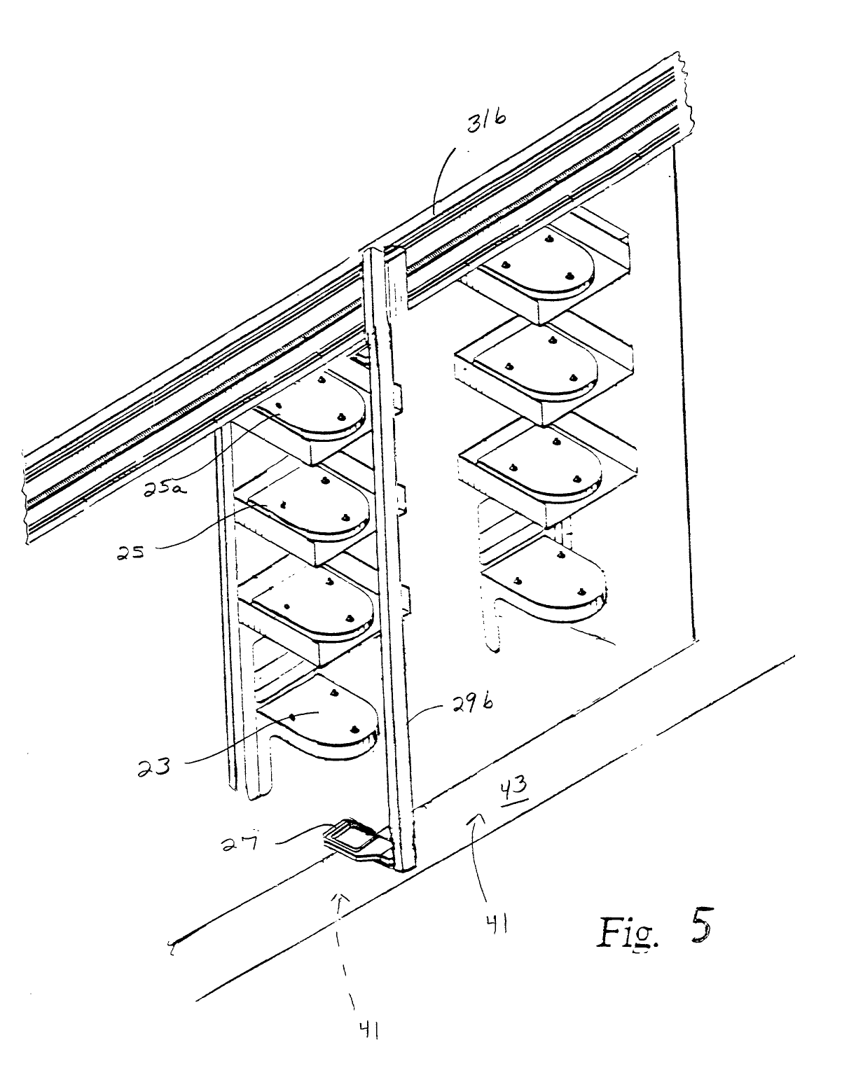

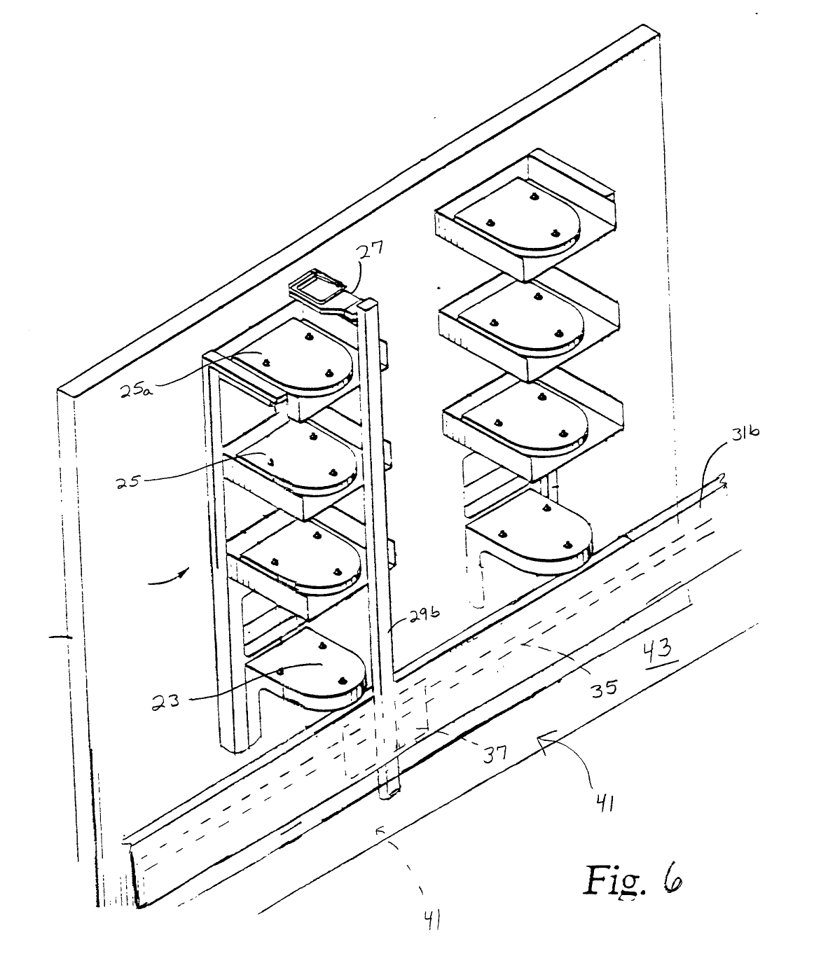

FIGS. 5 through 7 show nonmodular configurations 11c-e of the inventive loading and storage apparatus of FIGS. 2 through 4. Specifically FIGS. 5 and 6 show a nonmodular aspect wherein a horizontal guide 31b is stationarily mounted (e.g. to a floor, ceiling or wall of the cleanroom) and one or more vertical guides 29b are movably mounted to the horizontal guide 31c. FIG. 5 shows the horizontal guide 31b positioned above a top shelf 25a of the plurality of storage shelves and FIG. 6 shows the horizontal guide 31b positioned below the docking stations 23 with the vertical guide 29b extending both above and below the horizontal guide 31b so as to allow the end effector 27 to move the carrier 39 among the factory load location 41, the docking stations 23 and the plurality of storage shelves 25. Like the loading and storage apparatus of FIG. 3, in the aspect of FIG. 6, the mounting plate 37 of the horizontal guide 31 and the vertical guide 29 coupled thereto, are positioned behind the lead screw 35 (closer to the docking stations 23 and closer to the plurality of storage shelves 25) such that the lead screw 35 does not obstruct movement of the end effector 27.

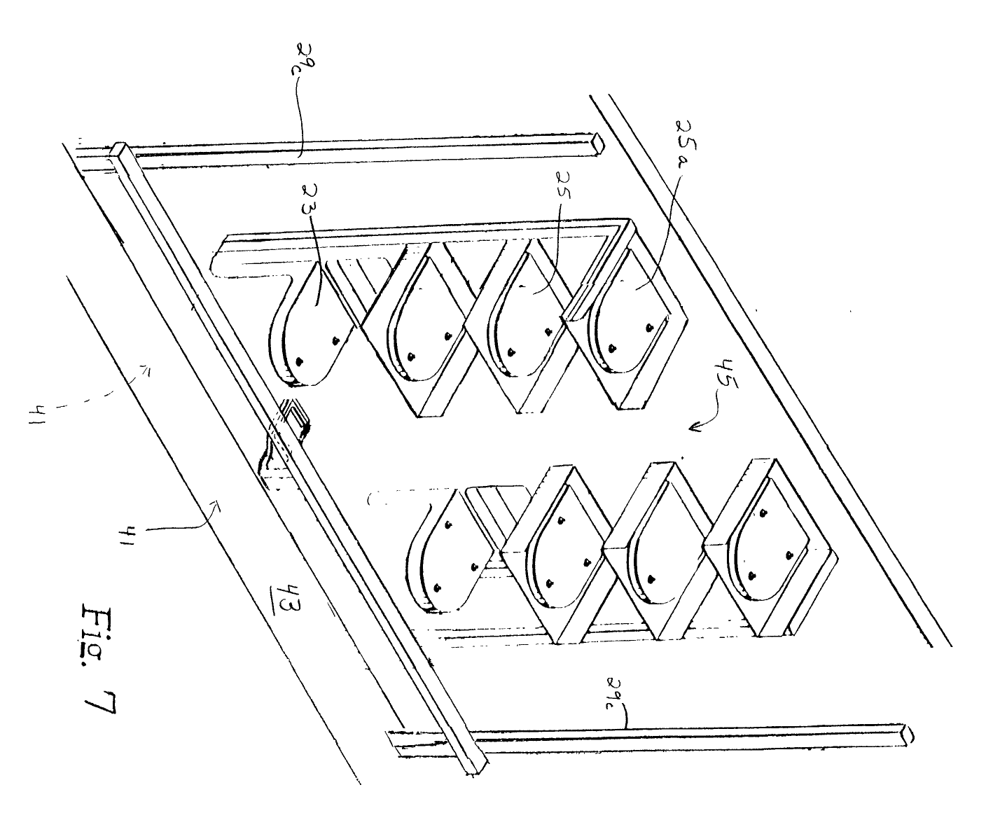

FIG. 7 shows a nonmodular aspect lie wherein a vertical guide 29c is stationarily mounted (e.g., to a floor, ceiling or wall of the cleanroom) and a movable horizontal guide 31c is movably coupled to the stationary vertical guide 29c. The vertical guide 29c extends vertically to a position wherein the end effector 27 can grasp a carrier 39 located on the factory load location 41. Like the aspect of FIG. 4, for added strength the vertical guide 29c may comprise two parts (the second part being shown in phantom in FIG. 7). The movable horizontal guide 31c, stationary vertical guide 29c and the end effector 27 are configured such that the end effector 27 is able to grip a carrier 39 positioned on the factory load location 41, yet such that the vertical guide 29c and the horizontal guide 31c do not obstruct the travel of the carrier 39 traveling along the conveyor 43. In each of FIGS. 5 through 7 the conveyor 43 is positioned below the docking stations 23 and is shown extending parallel the to the robot's horizontal guide 31.

Each of the aspects described with reference to FIGS. 2 through 7 above operate in a similar manner. Specifically carrier 39 travels along the conveyor 43 to the factory load location 41 wherein the carrier 39 is stopped (e.g., by stopping the operation of the conveyor 43, or by actuating a mechanical stop, etc.). The end effector 27 moves horizontally and vertically via the vertical and horizontal guides so as to grip the carrier 39 (e.g., via a top flange thereof as is known in the art). More specifically, the end effector may comprise a pair of ledges that extend parallel to the horizontal guide and are spaced by a distance less than the width of the substrate carrier's top flange. The end effector may grip the substrate carrier by moving horizontally to position the pair of ledges under the substrate carrier flange and then elevating such that the substrate carrier flange contacts the end effector ledges and the substrate carrier is supported thereby.

After the end effector 27 grips the carrier 39, the end effector 27 moves horizontally and vertically via the vertical and horizontal guides to place the carrier 39 either on one of the plurality of storage shelves 25 or on one of the docking stations 23. If the carrier 39 comprises a sealed pod such as a front opening unified pod (FOUP) the docking stations 23 may comprise a door opener such as that described in U.S. Pat. No. 6,082,951, issued Jul. 4, 2000, the entire disclosure of which is incorporated herein by this reference. In general, a docking station may open a FOUP door by receiving a FOUP, moving the FOUP horizontally to contact a FOUP door receiver having keys positioned to open one or more corresponding locks which lock the FOUP door to the main body of the FOUP. After the keys are actuated and the FOUP door is unlocked, the door receiver supports the FOUP door (e.g., via pins, vacuum suction, etc.) and lowers such that the substrates contained within the FOUP are accessible for extraction.

After the door of the FOUP is removed, the robot 19 of the front end robot chamber 15 (FIG. 1) extracts wafers from the FOUP and transports them to the loadlock 21 of the processing tool 13. From the loadlock 21 the wafers may be transported to a processing chamber P for subsequent processing. After the wafers are processed and returned to the open FOUP positioned on the docking station 23, the door receiver (not shown) seals the FOUP door back on the open FOUP. The end effector 27 then moves horizontally and vertically via the vertical and horizontal guides to extract the FOUP from the docking station 23 and transport it to one of the plurality of storage shelves 25 or to the factory load location 41. From the factory load location 41 the FOUP may be transported via the conveyor 43 to another processing apparatus.

The foregoing description discloses only the preferred embodiments of the invention, modifications of the above disclosed apparatus and method which fall within the scope of the invention will be readily apparent to those of ordinary skill in the art. For instance, although the exemplary embodiments refer to gripping a substrate carrier by a top flange (e.g., an overhead transport flange) thereof, it will be understood that substrate carrier designs may vary, and thus, the term “gripping” is not to be limited to methods which lift a carrier by its overhead transport flange. Further, although the figures show a stationary horizontal guide positioned above a top shelf of the plurality of storage shelves, it will be understood that the phrase “positioned above the docking station” includes any position above the docking station, and is not to be limited to the position above the top storage shelf. Similarly although the figures show the storage shelves, and docking stations positioned in vertical alignment directly above/below one and other (e.g., having the same footprint), the terms “above” and “below” are not to be limited thereto. For example, a factory load location below a docking station includes factory load locations that are adjacent to and at a lower elevation than the docking station.

Accordingly, while the present invention has been disclosed in connection with the preferred embodiments thereof, it should be understood that other embodiments may fall within the spirit and scope of the invention, as defined by the following claims.

The invention claimed is:

1. A loading and storage station comprising:
a docking station,
a plurality of storage shelves positioned above the docking station, each storage shelf configured to store a substrate carrier;
a factory load location positioned below the docking station; and
a robot having a support structure and an end effector coupled to the support structure, the support structure comprising a vertical guide and a horizontal guide configured so that the end effector may move horizontally and vertically among the docking station, the plurality of storage shelves and the factory load location.

2. The apparatus of claim 1 further comprising;
a support frame to which the plurality of storage shelves and at least one of the robot's vertical and horizontal guides are fixedly coupled.

3. The apparatus of claim 2 wherein the storage shelves and the docking station are vertically aligned so as to occupy the same footprint.

4. The apparatus of claim 2 wherein the storage shelves, the factory load location and the docking station are vertically aligned so as to occupy the same footprint.

5. The apparatus of claim 2 wherein the factory load location and the docking station are vertically aligned so as to occupy the same footprint.

6. The apparatus of claim 2 wherein the robot's horizontal guide is fixedly coupled to the support frame at a position above the docking station, and the vertical guide is moveably coupled to the horizontal guide and extends downwardly therefrom.

7. The apparatus of claim 2 wherein the robot's horizontal guide is fixedly coupled to the support frame.

8. The apparatus of claim 2 wherein the robot's vertical guide is fixedly coupled to the support frame and extends vertically to a position wherein the robot's end effector can grip a substrate carrier located at the factory load location, and wherein the horizontal guide is moveably coupled to the vertical guide.

9. The apparatus of claim 2 wherein the robot's horizontal guide is fixedly coupled to the support frame at a position above a top shelf of the storage shelves and the vertical guide is moveably coupled to the horizontal guide and extends downwardly therefrom to a position wherein the robot's end effector can grip a substrate carrier located at the factory load location.

10. The apparatus of claim 1 further comprising a conveyor adapted to transport substrate carriers to the factory load port location, wherein the support frame is configured so as not to obstruct a substrate carrier being transported by the conveyor.

11. The apparatus of claim 10 wherein the docking station and the conveyor are vertically aligned and wherein the conveyor and the robot's horizontal guide extend in parallel.

12. The apparatus of claim 10 wherein the robot's horizontal guide is fixedly coupled to the support frame at a position above the docking station, and the vertical guide is moveably coupled to the horizontal guide and extends downwardly therefrom to a position wherein the robot's end effector can grip a substrate carrier located at the factory load location.

13. The apparatus of claim 10 wherein the robot's horizontal guide is fixedly coupled to the support frame.

14. The apparatus of claim 10 wherein the robot's vertical guide is fixedly coupled to the support frame and extends vertically to a position wherein the robot's end effector can grip a substrate carrier located on the factory load location, and the horizontal guide is moveably coupled to the vertical guide.

15. The apparatus of claim 10 wherein the robot's horizontal guide is fixedly coupled to the support frame at a position above a top shelf of the storage shelves and the vertical guide is moveably coupled to the horizontal guide and extends downwardly therefrom to a position wherein the robot's end effector can grip a substrate carrier located on the factory load location.

16. The apparatus of claim 1 wherein the factory load location comprises a conveyor and the support frame is configured so as not to obstruct a substrate carrier being transported by the conveyor.

17. The apparatus of claim 1 wherein the robot's horizontal guide is fixedly coupled above the docking station, and the vertical guide is moveably coupled to the horizontal guide and extends downwardly therefrom.

18. The apparatus of claim 1 wherein the robot's horizontal guide is fixedly coupled to the support frame.

19. The apparatus of claim 1 wherein the robot's vertical guide is stationary and extends vertically to a position wherein the robot's end effector can grip a substrate carrier located at the factory load location, and the horizontal guide is moveably coupled to the vertical guide.

20. The apparatus of claim 1 wherein the robot's horizontal guide is stationarily positioned above a top shelf of the storage shelves and the vertical guide is moveably coupled to the horizontal guide and extends downwardly therefrom to a position wherein the robot's end effector can grip a substrate carrier located at the factory load location.

21. A method comprising:
providing a docking station;
receiving a substrate carrier at a factory load location positioned below the docking station;
lowering a robot end effector via vertical and horizontal guides to the factory load location below the docking station;
gripping the substrate carrier positioned on the factory load location;
elevating the robot end effector via the vertical and horizontal guides so as to lift the substrate carrier above the docking station; and
storing the substrate carrier on a storage shelf above the docking station.

22. The method of claim 20 further comprising storing the substrate carrier on one of a plurality of storage shelves positioned above the docking station.

23. The method of claim 20 further comprising conveying the substrate carrier along a conveyor positioned below the docking station.

24. The method of claim 22 further comprising conveying the substrate carrier to the factory load location and stopping the substrate carrier at the factory load location.

25. The method of claim 20 wherein lowering and elevating the robot end effector comprises lowering the end effector along the vertical guide to a position below the docking station and elevating the end effector along the vertical guide to a position above the docking station.

26. The method of claim 20 wherein lowering and =elevating the robot end effector comprises lowering the horizontal guide along the vertical guide to a position below the docking station and elevating the horizontal guide along the vertical guide to a position above the docking station.

27 The method of claim 21 further comprising conveying the substrate carrier along a conveyor below the docking station.

28 The method of claim 21 further comprising conveying the substrate carrier to the factory load location and stopping the substrate carrier at the factory load location.

29 The method of claim 21 wherein lowering and elevating the robot end effector comprises lowering the end effector along the vertical guide to a position below the docking station and elevating the end effector along the vertical guide to a position above the docking station.

30. The method of claim 21 wherein lowering and elevating the robot end effector comprises lowering the horizontal guide along the vertical guide to a position below the docking station and elevating the horizontal guide along the vertical guide to a position above the docking station.

31. The method of claim 22 wherein lowering and elevating the robot end effector comprises lowering the end effector along the vertical guide to a position below the docking station and elevating the end effector along the vertical guide to a position above the docking station.

32. The method of claim 22 wherein lowering and elevating the robot end effector comprises lowering the horizontal guide along the vertical guide to a position below the docking station and elevating the horizontal guide along the vertical guide to a position above the docking station.

33. The method of claim 22 further comprising moving the end effector horizontally, wherein moving and conveying occur along parallel lines.

34. The method of claim 23 wherein lowering and elevating the robot end effector comprises lowering the end effector along the vertical guide to a position below the docking station and elevating the end effector along the vertical guide to a position above the docking station.

35. The method of claim 23 wherein lowering and elevating the robot end effector comprises lowering the horizontal guide along the vertical guide to a position below the docking station and elevating the horizontal guide along the vertical guide to a position above the docking station.
